(19) United States
(12) Patent Application Publication
(10) Pub. No.: US 2003/0050975 A1
(43) Pub. Date: Mar. 13, 2003

(54) System and method for managing electronic documents including multimedia files

(76) Inventor: James G. Blaylock, Provo, UT (US)

Correspondence Address: TRASK BRITT, P.O. BOX 2550, SALT LAKE CITY, UT, 84110, US

(21) Appl. No.: 10/243,880

(22) Filed: Sep. 12, 2002

Related U.S. Application Data
(60) Provisional application No. 60/322,528, filed on Sep. 12, 2001.

(51) Int. Cl. G06F 15/16; G06F 17/30

(52) U.S. Cl. 709/203; 707/10

(57) ABSTRACT

The present invention is a document management system that allows easy access to all types of computer files and methods for same. According to a system embodiment of the present invention, the document management system includes a conventional Web browser on a client computer connected to a server computer that contains a database. Hard copies of documents may be scanned into the database and organized according to the user's preference. The computer files may be organized according to the user's preference and recalled using the Web browser to access the database. The present invention does not require any specialized software on the client-side or user interface. A scanner may be configured to communicate either directly or over a packet-based network connection with a client computer or server. Further, a memory storage device such as a CD-ROM can be used to back up the database on the server computer.

This utility patent application claims the benefit of provisional patent application Serial No. 60/322,528 filed on Sep. 12, 2001.

### FIELD OF THE INVENTION

This invention relates generally to office automation. More particularly, the invention relates to a system and method for creating, storing, retrieving and managing documents electronically.

### BACKGROUND OF THE INVENTION

Many service-oriented businesses, such as accounting firms, law firms and banks, have traditionally used paper files for managing documents relating to clients and matters. Such paper files may be organized in a number of different ways. For example, in the context of an accounting firm, files may be organized hierarchically by client at a top level and by years at the next level down. Thus, an accountant may organize the files for his client, using a large accordion file containing a number of manila files for each tax year for income tax purposes. Similarly, in the law firm context, an attorney may organize hard copies of documents by client number or matter number or both.

Occasionally, there is a need within a particular business to retain original hard copies of documents. But, for many businesses, it is sufficient to have access to a copy of an original document. The storage of hard copies of documents, i.e., paper files, can be cumbersome and expensive. Additionally, having backup hard copies of documents to avoid loss of information is generally impractical. Furthermore, there is risk of losing the information stored in original hard copies through fire, exposure to water and the natural aging process of the medium from which the hard copy is formed.

Conventional document management systems exist, but are typically very expensive and cumbersome to use. Thus, there exists a need in the art for an inexpensive, easy to use document management system that allows a user to manage many kinds of files, with an intuitive user interface through a conventional Web browser.

### SUMMARY OF THE INVENTION

The present invention is a document management system that allows easy access to all types of computer files, including spreadsheets, executable programs, data files and multi-media files (e.g., graphic images and full-motion video).

In one embodiment the document management system of the present invention uses a conventional Web browser on a personal computer connected to a server computer that contains a database. Documents may be scanned into the database and organized according to the user's preference from information entered in multiple data fields in a graphical user interface. The data files may be organized as desired and recalled using the web browser to access the database. The present invention does not require any specialized software on the client-side, or user interface.

In another embodiment, a scanner is configured to communicate either directly or over a network connection with a personal computer or server computer. In yet another embodiment, a memory storage device such as a CD-ROM or CD-R/W is used to back-up the database on the server computer. In still another embodiment a method for managing computer files electronically is disclosed.

The embodiments of the present invention will be readily understood by reading the following detailed description in conjunction with the accompanying figures of the drawings.

### BRIEF DESCRIPTION OF THE DRAWINGS

The drawings illustrate exemplary embodiments for carrying out the invention. Additionally, like reference numerals refer to like parts in different views or embodiments in the drawings.

FIG. 1 is block diagram of a system in accordance with the present invention.

FIG. 2 is a block diagram of another embodiment of a system in accordance with the present invention.

FIG. 3 is a block diagram of the database organization.

FIG. 4 is a flow diagram of a method for managing computer files electronically according to the present invention.

### DETAILED DESCRIPTION OF THE INVENTION

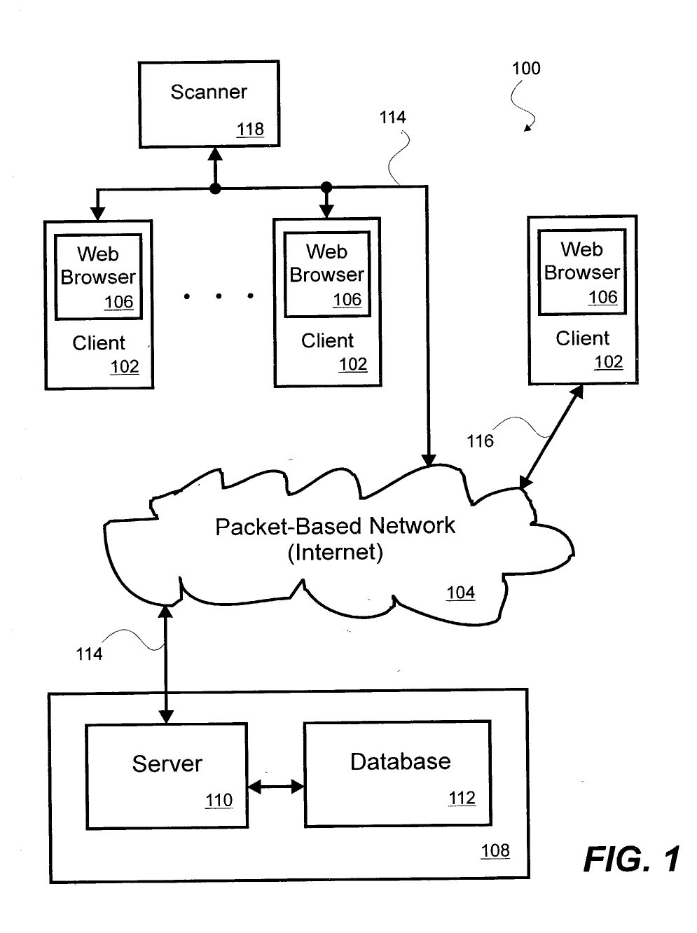

FIG. 1 is a block diagram of a system 100 in accordance with the present invention. System 100 may include at least one client 102 configured for a network connection 114 to a packet-based network 104. Network connection 114 may be a local area network (LAN) with server (not shown) or firewall (not shown) connecting to the packet-based network 104. Each client 102 includes a Web browser 106. System 100 may also include a server computer 108 including a server 110 and a database 112. Server 110 is configured to communicate with database 112. Server computer 108 may also be configured with a network connection 114 to packet-based network 104. Server computer 108 may be configured for network connection 114 to the same LAN as clients 102. Packet-based network 104 may be a LAN, a private Internet or a public Internet. The at least one client 102 may also be a remotely located personal computer with Internet access capability 116. Internet access capability 116 may be a narrowband dial-up connection to the Internet through an Internet service provider (not shown) or broadband Internet access, e.g., digital subscriber line (DSL) or cable modem. System 100 may also include a scanner 118 for scanning hard copies of documents for electronic storage in the database 112. The scanner 118 may be networked to clients 102 (as shown), directly connected to a client 102, or connected to the packet-based network 104. The terms “client” and “client computer” may be used interchangeably herein.

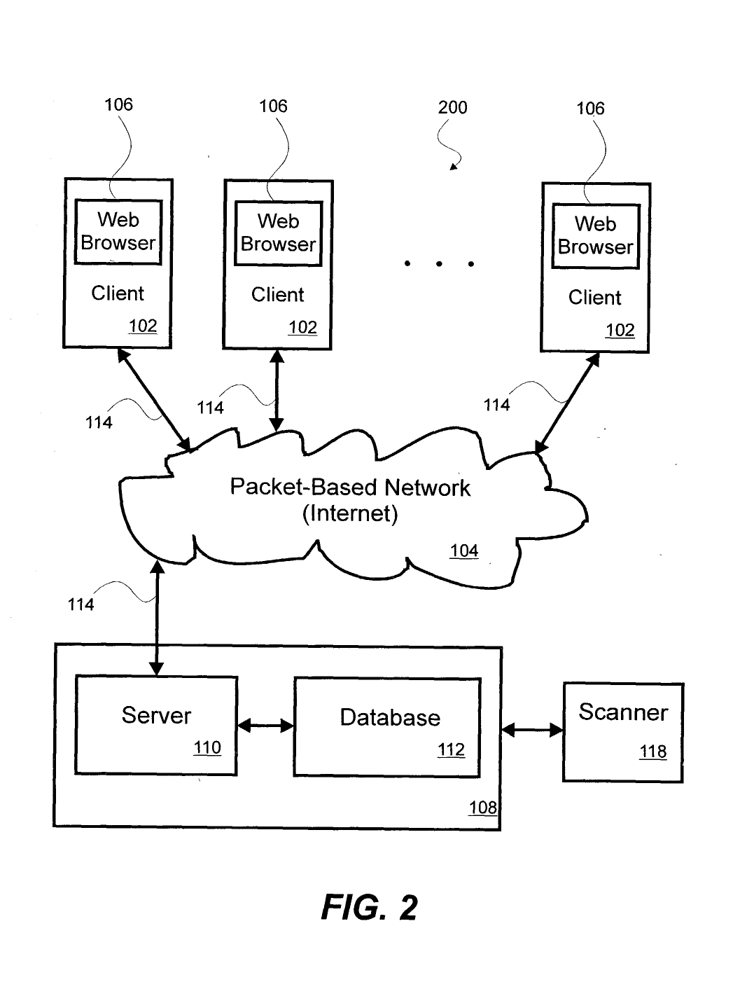

FIG. 2 is a block diagram of another embodiment of a system 200 in accordance with the present invention. System 200 may include a plurality of clients 102 (three shown), configured for a network connection 114 to a packet-based network 104. System 200 may also include a server computer 108 including a server 110 and a database 112. Server 110 is configured to communicate with database 112. Server computer 108 may also be configured with a network connection 114 to packet-based network 104. Server computer 108 may be configured for network connection 114 to the same LAN as clients 102. Packet-based network 104 may be a LAN, a private Internet or a public Internet. System 200 may also include a firewall (not shown) between server computer 108 and the packet-based network 104, for additional security. System 200 may also include a scanner 118 configured for communication directly (as shown, or over the packet-based network 104) with server computer 108 for scanning hard copies of documents for electronic storage in the database 112.

Database 112 may include an index that is fully text searchable. Database 112 may also include fields for client information, such as full name, address and contact information, phone numbers, email address, notes, and issues. Database 112 may be organized as any traditional file cabinet.

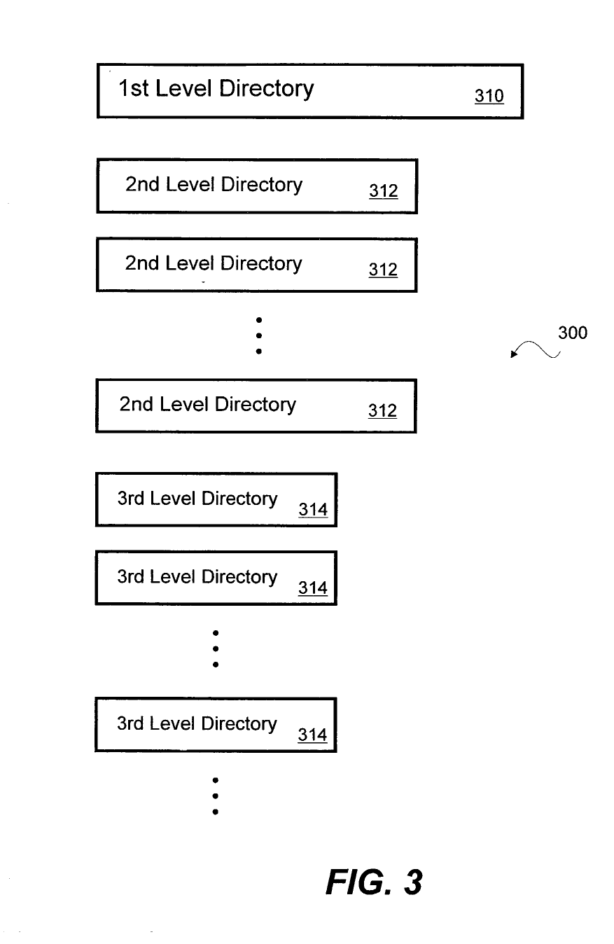

FIG. 3 is a block diagram of hierarchal directory structure 300 that can be used within database 112. For instance, a file may be set up in database 112 as a first level directory 210, called a file cabinet. Second level directories 212 can be set up within the file cabinet. Further, client information can be entered into multiple data fields provided in a graphical user interface when setting up the second level directory 212. The client information entered in the graphical user interface may be stored in database 112. In an exemplary embodiment, the client information entered in the graphical user interface is stored as a hidden file that is not viewed by the user of the system. Second level directories 212 are analogous to drawers in a traditional file cabinet. Within second level directories 212 or drawers, a third level directory 214 can be provided which is analogous to folders in the drawers of a traditional file cabinet. More directory levels can be added as desired. Files can be stored in any of the directories, but typically the files are stored within third level directory 214. In an exemplary embodiment, the application programs associated with the files may be opened automatically upon opening of the database program.

An example of the above hierarchal directory structure 300 in accordance with the present invention follows. A file cabinet may be set up called McDougal Clients containing multiple drawers for any number of specific clients such as Jonathan Appleseed, Martha Appleseed, etc. Within each drawer may be folders such as 2000 Audit, 2000 Tax, and 2001 Audit. Within each of these folders will be files such as 1040 tax forms, etc. Other variations will be apparent to those skilled in the art.

Database 112 can be arranged in a number of ways according to the desires and preferences of the user. In an exemplary embodiment, database 112 can be organized according to the information entered data fields in the graphical user interface when creating the second level directories. Database 112 is fully capable of searching any of the data fields entered in this graphical user interface. Other organizational arrangements will be apparent to those skilled in the art. Database 112 may further include a notepad for recording notes about a client or a particular directory. Conversion of information stored in conventional databases to the format of database 112 is contemplated to be within the scope of the present invention and the details for performing such conversion are considered to be within the scope of one of ordinary skill in the art, and thus, will not be further detailed herein.

Web browser 106 may be any conventional Web browser such as Internet Explorer™ from Microsoft, Redmond, Wash. and Netscape Navigator™. Each client 102 may be a computer configured for a network connection 114, including a processor, memory, an input device and an output device. However, the make and performance characteristics of such a computer for each client 102 are not critical to the invention. However, the computer should have sufficient memory and power to handle scanning operation. If the computer will be used to store data, approximately 1 GB per four filing cabinet drawers is required. Any personal computer with a Web browser 106 may be used consistent with the present invention. A presently preferred embodiment of the present invention has the following requirements: clients running Microsoft™ Windows 95™ or higher operating system and networked to server computer 108. Optional facsimile software such as WinFaxPro™ from Symantec Corporation, Cupertino, Calif. and Windows Fax Server 2000™ from Microsoft Corporation will enable a user to send facsimile copies of documents stored in database 112 from a networked facsimile machine or by email according to the present invention.

Network connections 114 may be direct connections to LAN through a network interface card (NIC). Alternatively, network connections 114 may include a modem connected to a telephone line with appropriate hardware and/or firmware and/or software and an account with an Internet Service Provider (ISP) necessary for an Internet connection.

Programs such as Adobe Acrobat™ can be used to convert scanned documents into “.pdf” files. Other graphic file formats such as tagged image file format or “.tif” files may be used when desired. Other file formats for use with scanned documents will be apparent to one skilled in the art. Systems 100, 200 may also include a compact disc recordable drive (CD-R), a compact disc re-writable drive (CD-RW), tape drive or magneto-optic (MO) drive for backing up the contents of the database 112. Packet-based network 104 may be a LAN, a wide area network (WAN), the public Internet, an Intranet, or a private Internet. Thus, clients 102 may be connected to a LAN in a single facility, a WAN interconnecting many facilities, or a large scale network such as the Internet.

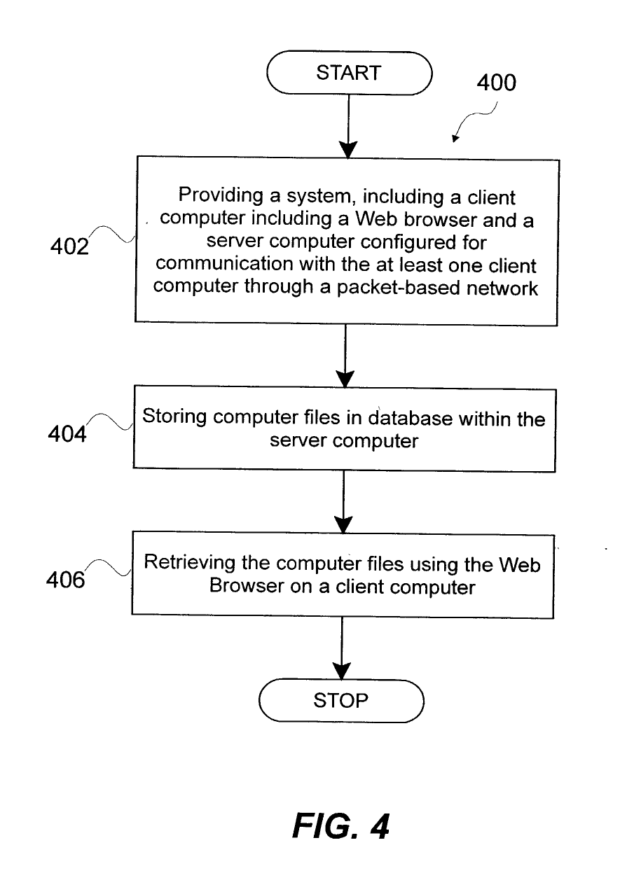

FIG. 4 is a flow diagram of a method 400 for managing computer files electronically according to the present invention. Method 400 may include providing 402 a system, including a client computer including a Web browser and a server computer configured for communication with the client computer through a packet-based network. Method 400 may further include storing 404 computer files in database within the server computer and retrieving 406 the computer files using the Web Browser on the client computer.

While some of the exemplary embodiments described above refer to an accounting firm as an application for the invention, the invention is not so limited. Any application that requires document management for more than one user may be an applicable environment for the present invention, including law firms, banks, educational institutions, and government institutions. Although this invention has been described with reference to particular embodiments, the invention is not limited to these described embodiments. Rather, the invention is limited only by the appended claims, which include within their scope all equivalent devices or methods that operate according to the principles of the invention as described herein.

What is claimed is:

1. A system for managing documents electronically, comprising:
at least one client computer including a Web browser; and
a server computer configured for communication with said at least one client computer through a packet-based network, said server computer comprising:
a server;
a database in communication with said server for storing files; and
a graphical user interface (GUI) installed on said server and accessible to a user from said at least one client computer using said Web browser for accessing said files, said GUI comprising:
a first level directory; and
a second level directory within said first level directory and indexed according to data fields entered in a data entry window of said GUI.

2. The system of claim 1, wherein said database further comprises at least one third level directory within said second level directory.

3. The system of claim 2, wherein said database further comprises at least one file stored within said second level directory or said third level directory.

4. The system of claim 1, wherein said GUI is a hypertext markup language (HTML) page.

5. The system of claim 1, further comprising at least one scanner configured for direct communication with said at least one client computer or said server computer.

6. The system of claim 1, further comprising at least one scanner for communication with said at least one client computer or said server computer through a packet-based network.

7. The system of claim 1, further comprising a memory storage device coupled to said server computer for backing up said database.

8. The system of claim 1, wherein said data fields include at least one of a client name, a client address, a customer number, a social security number, a phone number, an email address or notes.

9. A method for managing computer files electronically, comprising:
providing a system, said system comprising:
at least one client computer including a Web browser; and
a server computer configured for communication with said at least one client computer through a packet-based network, said server computer comprising:
a server for hosting a Web site; and
a database in communication with said server for storing computer files and accessible to a user from said at least one client computer using said Web browser comprising:
a first level directory; and
a second level directory within said first level directory and indexed according to data fields entered in a graphical user interface (GUI) of said Web site;
storing said computer files in said database; and
retrieving said computer files using said Web Browser on said at least one client computer.

10. The method of claim 9, wherein said storing said computer files comprises storing multimedia files.

11. The method of claim 9, wherein retrieving said computer files using said Web Browser comprises launching an application program associated with each of said computer files.

12. The method of claim 9, further comprising scanning hard copies of documents for storage as said computer files.

13. The method of claim 9, wherein providing said server computer including said database further comprises at least one third level directory within said second level directory.

14. The method of claim 13, further comprising storing said computer files in said second level directory or said third level directory.

15. The method of claim 9, wherein providing a system further comprises including a memory storage device coupled to said server computer for backing up said database.

16. The method of claim 9, wherein said database having a second level directory containing said data fields includes at least one of a client name, a client address, a customer number, a social security number, a phone number, a email address, or notes.

17. The method of claim 9, further comprising text searching said data fields entered in said GUI.

18. The method of claim 9, further comprising arranging said second level directory according to said data fields entered in said GUI.
